(19) United States
(12) Patent Application Publication
(10) Pub. No.: US 2019/0286453 A1
(43) Pub. Date: Sep. 19, 2019

(54) SYSTEM CONSTRUCTION ASSISTING APPARATUS, METHOD, AND PROGRAM

(71) Applicant: NEC Corporation, Minato-ku, Tokyo (JP)

(72) Inventor: Satoshi YAMAZAKI, Tokyo (JP)

(73) Assignee: NEC Corporation, Minato-ku, Tokyo (JP)

(21) Appl. No.: 16/343,061

(22) PCT Filed: Oct. 17, 2017
(86) PCT No.: PCT/JP2017/037571

§ 371 Date: Apr. 18, 2019

(30) Foreign Application Priority Data
Nov. 1, 2016 (JP) 2016-214403

(51) Int. Cl. G06F 9/445; G06F 11/34; G06F 9/455

(52) U.S. Cl. CPC G06F 9/44505; G06F 2009/45562; G06F 9/45558; G06F 11/3457

(57) ABSTRACT

A system construction assisting apparatus according to the present invention includes a task confirmation means 501 that changes, with information indicating a configuration change task to be verified, information indicating a state that each constituent element of a target system can enter, and information indicating a state transition task for making transition of each constituent element between the states serving as input, a state of a simulated system that performs operation same as operation of the target system and executes the configuration change task to obtain an execution result of the configuration change task in all system states that the target system can enter, and a dependence relationship calculation means 502 that calculates a dependence relationship of each of the configuration change task on the basis of the obtained execution result and outputs information indicating a calculated dependence relationship.

### TECHNICAL FIELD

The present invention relates to a system construction assisting apparatus, a method of assisting system construction, and a system construction assisting program for assisting system construction.

### BACKGROUND ART

Construction of a software system requires preparation of an environment in which a required service normally operates. In order to prepare such an environment, it is necessary to appropriately execute a task (hereinafter referred to as a configuration change task) such as a patch job for performing system construction such as middleware installation, a service start-up, and configuration file deployment.

System construction according to the present invention includes a case where a system configuration is changed, that is, a case where an existing system is modified to construct a new system. Similarly, the configuration change task includes a task for adding/deleting a constituent element to/from a current system configuration and a task for changing a state of a constituent element.

In recent years, a system operation environment and software are diversified, whereby advanced knowledge is required to utilize such a configuration change task.

The advanced knowledge mentioned above includes a dependence relationship between configuration change tasks. More specifically, the dependence relationship between configuration change tasks indicates an order relationship in which, for example, installation of a package B must be executed first to install a package A of certain software. It may be said that, according to more detailed analysis, the order relationship between configuration change tasks is a dependence relationship between the configuration change task and a state of a constituent element in which, for example, a state of a certain constituent element must be C to make a transition of a system state to a certain state. Therefore, as expert knowledge, a system builder may make the state of the constituent element that is a precondition of the configuration change task, that is, the dependence relationship between the configuration change task and the state of the constituent element, to be held instead of the dependence relationship between the configuration change tasks. Such a dependence relationship may occur not only in installing a package but also in changing various systems. If the dependence relationship is ignored and the configuration change task is executed in an incorrect order or without conforming to the precondition, failures may occur.

In relation to a technique for appropriately constructing a system, there has been known a technique of managing the dependence relationship between constituent elements of the system to execute the configuration change task in an appropriate order (e.g., see Patent Literature 1, Patent Literature 2, Non Patent Literature 1, and Non Patent Literature 2).

In particular, a method disclosed in Patent Literature 1 defines a system as aggregation of states of constituent components to cope with a case where an existing system is changed in addition to a case where a system is constructed from scratch. For example, in the method disclosed in Patent Literature 1, a state transition in a constituent component is associated with a configuration change task to specify an expected state of another constituent component at the time of executing the state transition of a certain constituent component, thereby managing a dependence relationship between the configuration change task and the state of the constituent component.

Note that Chef described in Non Patent Literature 1 and Puppet described in Non Patent Literature 2 are a type of a configuration management tool for automating cloud computing. In either case, a state of a server is managed in code, whereby the server is automatically constructed.

In addition, Patent Literature 3 discloses a method of calculating a dependence relationship between configuration change tasks from an execution log. Patent Literature 3 also disclose a solution to the case where the execution logs becomes a vast amount.

### CITATION LIST

### Patent Literature

PTL 1: Japanese Patent Application Laid-Open No. 2015-215885
PTL 2: International Publication No. 2014/049854
PTL 3: Japanese Patent Application Laid-Open No. 2011-128828

### Non Patent Literature

NPL 1: Puppet enterprise, “Instruction as code—the foundation for DevOps I Puppet”, [Retrieved on Oct. 4, 2016], Internet <URL: https://puppet.com/solutions/infrastructure-as-code>
NPL 2: Chef Software, Inc., “Infrastructure Automation I Chef”, [Retrieved on Oct. 4, 2016], Internet <URL: https://www.chefio/solutions/infrastructure-automation/>

### SUMMARY OF INVENTION

### Technical Problem

According to the methods disclosed in Patent Literature 1, Patent Literature 2, Non Patent Literature 1, and Non Patent Literature 2, a system builder must input a file or the like describing a required dependence relationship. Accordingly, those methods may raise a problem that all dependence relationships related to the configuration change task to be used in system construction need to be manually described, which is troublesome. In addition, according to those methods, system construction may fail when the system builder input an incorrect dependence relationship, for example. Furthermore, those methods may raise a problem that there is no method of confirming accuracy of the dependence relationship so that correctness/errors of the dependence relationship cannot be determined unless the configuration change task is actually executed to obtain a result thereof. As described above, those methods are troublesome and errors in the real environment cannot be suppressed, whereby there may be a problem that they cannot be used unless the system builder has correct knowledge related to the dependence relationship between constituent elements required for constructing a targeted system.

In addition, in the method disclosed in Patent Literature 3, in order to derive the dependence relationship between required configuration change tasks, an execution log needs to include execution results in all situations in which those configuration change tasks can be executed. For example, the method may raise a problem that the dependence relationship cannot be derived correctly if even one required task execution result is not included in the execution log. Furthermore, according to the method, it is determined whether or not a procedure is executable only on the basis of the task execution result included in the execution log, that is, success or failure of the task execution, and no consideration on a state of the system before the task execution is made. Therefore, even if the task execution result differs depending on the system state before the task execution, the cause may not be specified and the dependence relationship between configuration change tasks may not be derived correctly.

For example, it is assumed that an unintended portion has been changed in a certain constituent component in the past to improve reusability. Such a task of changing an unintended portion should be determined to be impermissible at the time of constructing a system. However, according to the existing method of analyzing execution logs, it cannot be determined whether the task in the execution log is a change of an unintended portion.

If the dependence relationship in the system required at the time of generating a system construction procedure, more specifically, the dependence relationship between the configuration change tasks or between the configuration change task and the state of the constituent element can be correctly extracted without manual operation, it is possible to verify whether the dependence relationship described manually is correct.

In view of the problems described above, an object of the present invention is to provide a system construction assisting apparatus, a method of assisting system construction, and a system construction assisting program capable of correctly and easily extracting a dependence relationship between configuration change tasks or between a configuration change task and a state of a constituent element.

### Solution to Problem

A system construction assisting apparatus according to the present invention includes a task confirmation means that changes, with information indicating a configuration change task to be verified, information indicating a state that each constituent element of a target system can enter, and information indicating a state transition task for making transition of each constituent element between the states serving as input, a state of a simulated system that performs operation same as operation of the target system and executes the configuration change task to obtain an execution result of the configuration change task in all system states that the target system can enter, and a dependence relationship calculation means that calculates a dependence relationship of each of the configuration change task on the basis of the obtained execution result and outputs information indicating a calculated dependence relationship.

A method of assisting system construction according to the present invention includes steps of changing, when information indicating a configuration change task to be verified, information indicating a state that each constituent element of a target system can enter, and information indicating a state transition task for making transition of each constituent element between the states are input, a state of a simulated system that performs operation same as operation of the target system, and executing the configuration change task to obtain an execution result of the configuration change task in all system states that the target system can enter, and calculating a dependence relationship of each of the configuration change task on the basis of the obtained execution result, and outputting information indicating a calculated dependence relationship.

A system construction assisting program according to the present invention causes a computer to perform processing of changing, with information indicating a configuration change task to be verified, information indicating a state that each constituent element of a target system can enter, and information indicating a state transition task for making transition of each constituent element between the states serving as input, a state of a simulated system that performs operation same as operation of the target system and executing the configuration change task to obtain an execution result of the configuration change task in all system states that the target system can enter, and processing of calculating a dependence relationship of each of the configuration change task on the basis of the obtained execution result and outputting information indicating a calculated dependence relationship.

### Advantageous Effects of Invention

According to the present invention, the dependence relationship between the configuration change tasks or between the configuration change task and the state of the constituent element can be correctly extracted.

### BRIEF DESCRIPTION OF DRAWINGS

FIG. 1 It depicts a block diagram illustrating an exemplary configuration of a dependence relationship extracting apparatus according to a first exemplary embodiment.

FIG. 2 It depicts an explanatory diagram illustrating an example of verification environment information 101.

FIG. 3 It depicts an explanatory diagram illustrating an example of constituent element model information 102.

FIG. 4 It depicts an explanatory diagram illustrating another example of the constituent element model information 102.

FIG. 5 It depicts an explanatory diagram illustrating an example of confirmation means information 103.

FIG. 6 It depicts an explanatory diagram illustrating another example of the confirmation means information 103.

FIG. 7 It depicts an explanatory diagram illustrating an example of initial state information 111.

FIG. 8 It depicts an explanatory diagram illustrating an example of all-state transition information 122.

FIG. 9 It depicts an explanatory diagram illustrating an example of changing means information 121.

FIG. 10 It depicts an explanatory diagram illustrating another example of the changing means information 121.

FIG. 11 It depicts an explanatory diagram illustrating an example of a change result 131.

FIG. 12 It depicts an explanatory diagram illustrating another example of the change result 131.

FIG. 13 It depicts an explanatory diagram illustrating an example of information to be stored in a change result storage unit 140.

FIG. 14 It depicts an explanatory diagram illustrating another example of the information to be stored in the change result storage unit 140.

FIG. 15 It depicts an explanatory diagram illustrating an example of dependence relationship information 151.

FIG. 16 It depicts a flowchart illustrating an outline of operation of a dependence relationship extracting apparatus 100.

FIG. 17 It depicts a flowchart illustrating exemplary operation of a verification environment construction unit 110.

FIG. 18 It depicts a flowchart illustrating exemplary operation of a state search unit 120.

FIG. 19 It depicts a flowchart illustrating exemplary operation of a state change unit 130.

FIG. 20 It depicts a flowchart illustrating exemplary operation of a dependence relationship calculation unit 150.

FIG. 21 It depicts a block diagram illustrating an outline of the present invention.

FIG. 22 It depicts a block diagram illustrating another exemplary configuration of a system construction assisting apparatus according to the present invention.

### DESCRIPTION OF EMBODIMENTS

Hereinafter, an exemplary embodiment of the present invention will be described with reference to the accompanying drawings.

Note that each drawing illustrates an exemplary embodiment of the present invention. Therefore, exemplary embodiments of the present invention are not limited to the illustration in each drawing. In addition, similar configurations in respective drawings are denoted by the same numerals, and repeated description may be omitted in some cases. In each drawing, illustration of a configuration of a part not related to explanation of the present invention may also be omitted in some cases.

Furthermore, in the following descriptions, although the expression of transmitting (outputting) is used when a first constituent element passes necessary information to a second constituent element, information exchange is not limited to such operation. For example, the first constituent element may store generated (calculated) or received information in a storage unit, and the second constituent element may read necessary information from this storage unit. In such a case, the exemplary embodiment of the present invention may include the storage unit (not illustrated).

### First Exemplary Embodiment

Hereinafter, a dependence relationship extracting apparatus 100 according to a first exemplary embodiment of the present invention will be described with reference to the accompanying drawings. The dependence relationship extracting apparatus 100 according to the first exemplary embodiment is an example of a system construction assisting apparatus according to the present invention, which performs processing of extracting a dependence relationship between a configuration change task required for constructing a target system and a state of a constituent element.

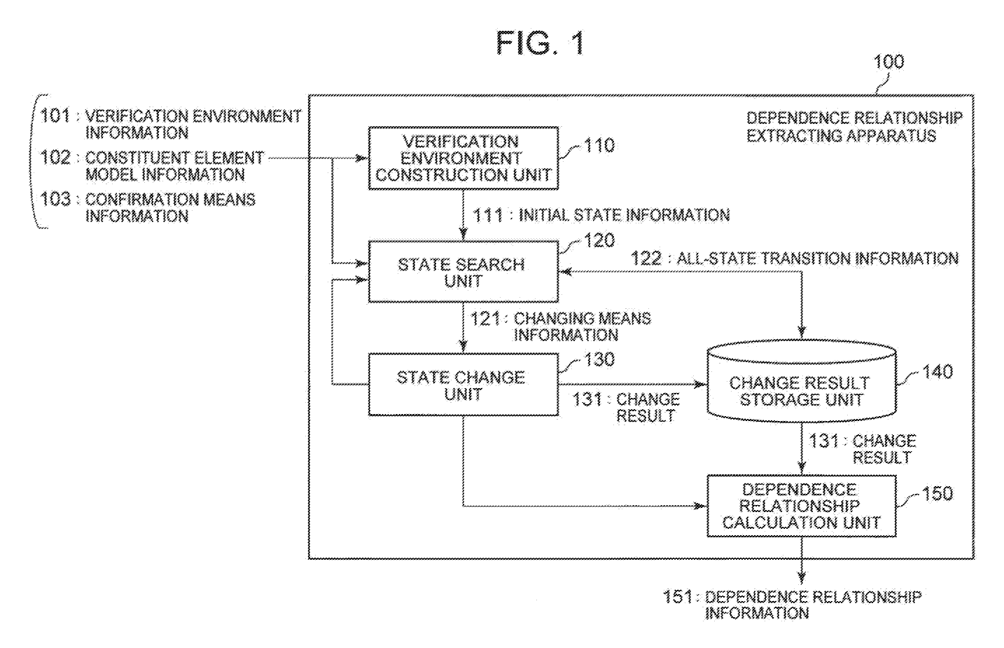

FIG. 1 is a block diagram illustrating an exemplary configuration of the dependence relationship extracting apparatus 100 according to the first exemplary embodiment. The dependence relationship extracting apparatus 100 illustrated in FIG. 1 includes a verification environment construction unit 110, a state search unit 120, a state change unit 130, a change result storage unit 140, and a dependence relationship calculation unit 150.

The dependence relationship extracting apparatus 100 according to the present exemplary embodiment examines whether all configuration change tasks defined in input constituent element model information 102 are executable in a verification environment, thereby extracting the dependence relationship between the target configuration change task and the state of the constituent element. More specifically, the dependence relationship extracting apparatus 100 searches a state that follows a target system, and associates all state transitions of the target system found in the state search with the configuration change task. Then, the dependence relationship extracting apparatus 100 sequentially checks respective configuration change tasks associated with the state transition of the target system in such a manner in the verification environment. Here, the state search following the target system indicates transitioning a constituent element state of a simulated system that is the verification environment according to the state transition of the constituent element model indicated by the constituent element model information 102, and searching for all states that the simulated system can enter as a result of the transition. At this time, the state of the simulated system after the transition is retained and managed to be consistent with the current state when a similar state transition is performed in the target system.

Further, the dependence relationship extracting apparatus 100 generates a change result 131 indicating the execution result of the corresponding configuration change task for all searchable state transitions, and generates and outputs dependence relationship information 151 indicating the dependence relationship between the configuration change task and the state of the constituent element on the basis of the generated change result 131.

In the configuration illustrated in FIG. 1, the verification environment construction unit 110 obtains verification environment information 101, the constituent element model information 102, and confirmation means information 103. A method of obtaining information is not particularly limited. For example, a user of the dependence relationship extracting apparatus 100 may transmit those pieces of information to the dependence relationship extracting apparatus 100 using an input device (not illustrated). Further, the user may directly operate the dependence relationship extracting apparatus 100 to input those pieces of information to the dependence relationship extracting apparatus 100, for example.

The verification environment construction unit 110 constructs the simulated system to be the verification environment on a virtual machine prepared for verification on the basis of the obtained verification environment information 101. For example, the verification environment construction unit 110 performs a construction process such as a virtual machine start-up, installation of middleware necessary for verifying the operation, and configuration file deployment according to the verification environment information 101. Furthermore, after the construction of the simulated system is performed according to the verification environment information 101, the verification environment construction unit 110 confirms an initial state of the simulated system on the basis of the confirmation means information 103. Upon confirmation of the initial state, the verification environment construction unit 110 transmits initial state information 111 indicating the initial state of the simulated system to the state search unit 120.

The verification environment information 101 is information associated with the simulated system as a verification environment for performing the operation same as the target system. The verification environment information 101 includes information for constructing the simulated system, more specifically, information necessary for starting up the simulated system and undergoing transition to an initial state in which service is available.

As a specific example, the verification environment information 101 may include information associated with basic elements that forms the basis of the system construction such as cloud-based software to be used for operation verification, a virtual machine to be activated, a package to be deployed, and a configuration file, and procedure information for operating those basic elements and constructing a simulated system. Here, the information associated with the cloud-based software may be, for example, information indicating a type of the cloud environment to be used and an access method for operating the cloud-based software. The information associated with the virtual machine may be, for example, information indicating an image file to be used and a location on the network (assignment of IP address, etc.). The information associated with the package and the configuration file may be information indicating a type of the package, access information to the package, package-specific detailed information, and a location of the configuration file. Note that those pieces of information may be generated using configuration management tools disclosed in Non Patent Literature 1 and Non Patent Literature 2.

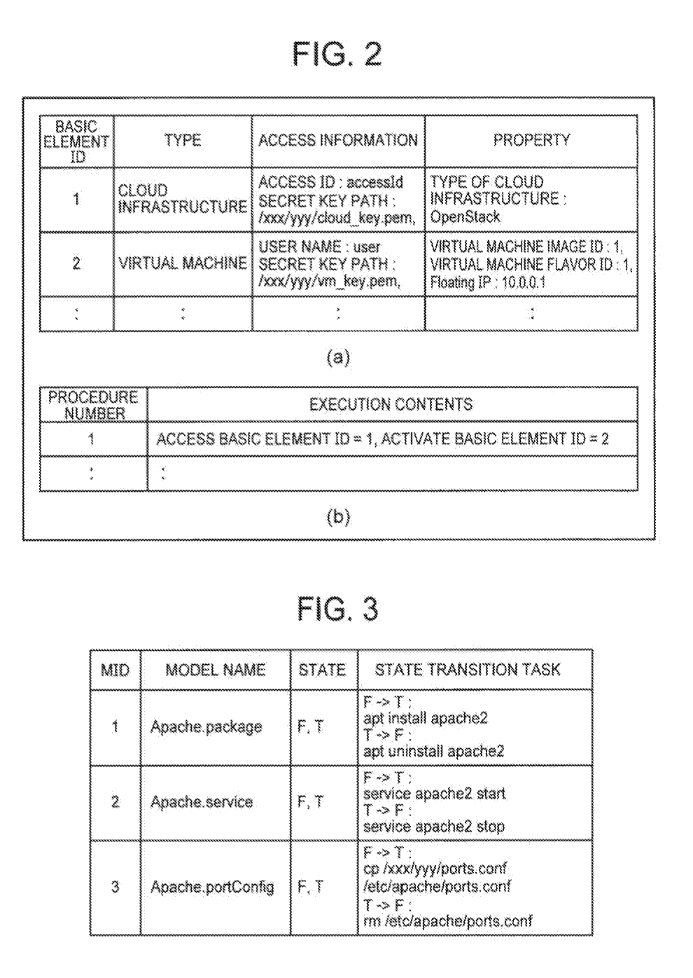

FIG. 2 is an explanatory diagram illustrating an example of the verification environment information 101. As illustrated in FIG. 2, the verification environment information 101 may include system configuration information and system construction procedure information. Note that FIG. 2(a) illustrates an example of the system configuration information, and FIG. 2(b) illustrates an example of the system construction procedure information.

The system configuration information is information indicating a configuration of the simulated system that is the verification environment. Specifically, information associated with a basic element of the simulated system, such as a cloud infrastructure and a virtual machine required for constructing the simulated system, is recorded. For example, the system configuration information may include a basic element identifier (ID), a type, access information, and a property (attribution or setup value).

The basic element ID is an identifier assigned to each basic element. The type may be anything as long as it indicates a functional classification of the basic element such as a cloud infrastructure, a virtual machine, and middleware. The access information is information for accessing each constituent element. The access information may include, for example, information of a uniform resource locator (URL), an Internet protocol (IP) address, a user name, and a password required for operating the constituent element.

Incidentally, when the cloud infrastructure or the virtual machine is accessed, access control based on RSA public key authentication may be performed in some cases. In such a case, the access information may further include a key name to be used and a path of a secret key. When the basic element is middleware, desired operation may be performed at times without any special information as long as the virtual machine can be accessed. In that case, the access information may be omitted, or may be left blank. Further, also in the case where remote access is not required, such as when the dependence relationship extracting apparatus 100 is directly connected to the verification environment and when the verification environment is locally deployed to perform operation verification, the access information may be omitted or left blank. Note that the access information is used in all operations for accessing the simulated system that is the verification environment in the dependence relationship extracting apparatus 100.

In the property, detailed information specific to the basic element, such as an attribution and a setup value of each basic element, is described. For example, when the basic element is cloud-based, the property of the system configuration information may include a type of the cloud-based software. An application programming interface (API) for operating the cloud-based software differs depending on the type of the cloud infrastructure. With the type of the cloud-based software being included in the property of the system configuration information, the dependence relationship extracting apparatus 100 (more specifically, verification environment construction unit 110) may determine a difference in API.

Further, when the basic element is the virtual machine, the property may include an image ID of the virtual machine, a hardware configuration ID (virtual machine flavor ID) such as a CPU and a memory, and an IP address (floating IP) to be assigned to the virtual machine.

Note that the information (item) to be described in the property and its value are not limited to the above, and the property only needs to include items and values required for operating the basic element.

Furthermore, as illustrated in FIG. 2(b), the system construction procedure information may include a procedure number that is an order of operations to be executed to construct the simulated system on the virtual machine prepared for verification, and information associated with execution contents that is contents of the operations. The information associated with execution contents may be a path or an execution command of a program or a script to be executed. In addition, when the execution command uses the basic element information as an argument, it is also possible to designate the information using the basic element ID.

Note that the user may also generate the system construction procedure information using the definition based on the text of the state machine group disclosed in Patent Literature 1.

FIG. 3 is an explanatory diagram illustrating an example of the constituent element model information 102. The constituent element model information 102 is information that models the state transitions that can be taken on the target system for each constituent element of the target system. For example, as illustrated in FIG. 3, the constituent element model information 102 may include a model name, a state, and a state transition task in association with an MID that is an identifier of each constituent element included in the target system. Note that each row of the table illustrated in FIG. 3 corresponds to the constituent element model information corresponding to one constituent element. A unit of the constituent element of the target system is not particularly limited. For example, it may be an arbitrary functional unit provided in software operating in the target system. Besides, definition of the state of the constituent element is also not particularly limited.

Here, the model name is a name given to a model of the constituent element of the target system. Although a name is given to a model of the constituent element to be easily identified by the user in the present example, the model name may be omitted. Besides, the state includes all states that the constituent element can enter on the target system. For example, when the constituent element is in a functional unit called a package of Apache, “F” representing a state in which the package is not installed and “T” representing an installed state are defined as states that the constituent element can enter. In the example illustrated in FIG. 3, two states of F and T are described as states of the model with the model name of “Apache.package”.

The state transition task is a task to be executed for making a transition of the state of the constituent element indicated by the model name. Note that the state transition task can also be said to be a configuration change task for changing a state of the system on the basis of the state transition of the constituent element. In the information associated with the state transition task, tasks corresponding to all state transitions that the constituent element can enter in the target system are described (defined). Specifically, the task to be executed to make a transition between those states is described (defined) on the basis of the state defined in the “state” column.

For example, in the case where a command “Command” is to be executed to make a transition from a state X to a state Y, the state transition task may be defined as “X->Y: Command”. In the example illustrated in FIG. 3, as a configuration change task for making a transition of the constituent element of the model name “Apache.package” from the state F to the state T, an execution command “apt install apache2” is defined after “F->T” representing the state transition. In the portion representing the execution command of the state transition task, a program to be executed or a script name may be described.

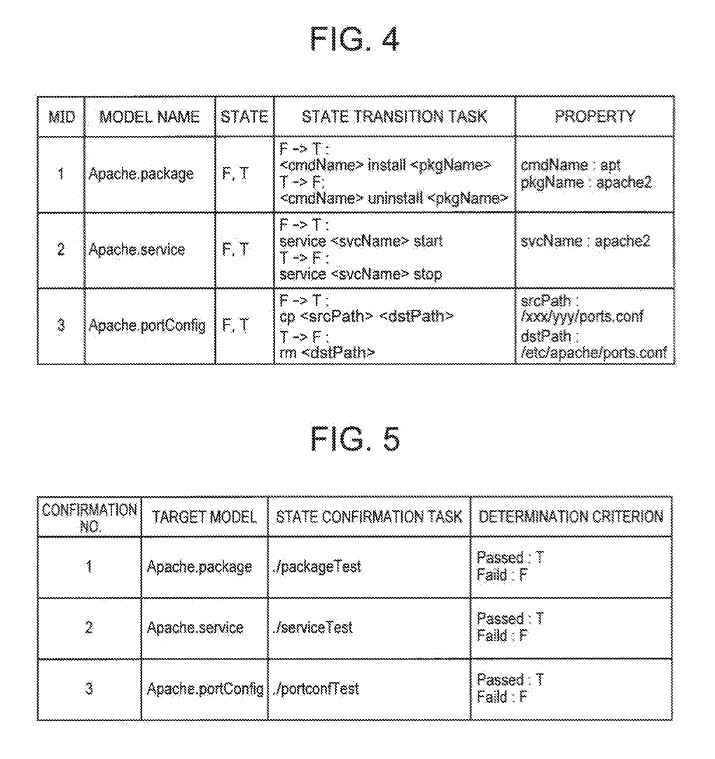

FIG. 4 is an explanatory diagram illustrating another example of the constituent element model information 102. As illustrated in FIG. 4, in the constituent element model information 102, it is also possible to introduce an arbitrary variable such as <cmdName> into the information associated with the state transition task. In such a case, the constituent element model information 102 may further include, as a property, an attribution having a specific value of the variable of the state transition task.

Note that the user may also generate the constituent element model information 102 using the definition based on the text of the state machine group disclosed in Patent Literature 1.

FIG. 5 is an explanatory diagram illustrating an example of the confirmation means information 103. The confirmation means information 103 is information associated with a state confirmation means for confirming the state of all constituent elements to be verified. The confirmation means information 103 may include, for example, information associated with a specific task for confirming the state of the constituent element and determination criterion for determining the state from the execution result. Note that each row of the table corresponds to information associated with one state confirmation means in the example illustrated in FIG. 5. As illustrated in FIG. 5, the confirmation means information 103 may include a target model, a state confirmation task, and a determination criterion in association with a confirmation number that is identification information of the state confirmation means.

Here, the target model is a model of the constituent element whose state is to be confirmed by the state confirmation means. The state confirmation task is a task to be executed to confirm the state of the target model. For example, a command of a state confirmation test to be executed by accessing the verification environment may be described in the confirmation means information 103 as the information of the state confirmation task. The determination criterion is a criterion for determining the state of the target model. In the determination criterion, information for specifying the state of the target model is described from the information obtained as a result of execution of the state confirmation task.

For example, in the example illustrated in FIG. 5, information associated with the state confirmation test for confirming the state of the target model “Apache.package” is described as information associated with the state confirmation task of confirmation number=1. More specifically, a path of the program for confirming the state is described. Meanwhile, “Passed: T” that is the determination criterion indicates that in the case where, as a result of executing the state confirmation test “./packageTest” as the state confirmation task, all the state confirmation tests have passed, the state of the target model is determined to be T in which the state confirmation task has normally terminated. For example, in the case where the determination criterion is “Failed: F”, when the specified state confirmation tests are executed and even one of them fails, the state of the target model is determined to be F in which the state confirmation task has not normally terminated.

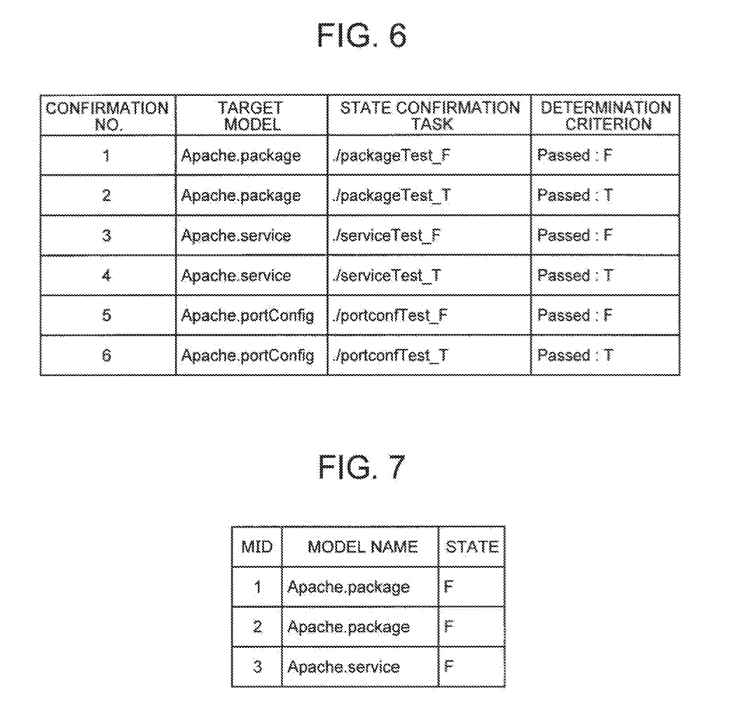

FIG. 6 is an explanatory diagram illustrating another example of the confirmation means information 103. As illustrated in FIG. 6, the state confirmation means may be assigned to each state of each constituent element. In the example illustrated in FIG. 6, the confirmation number is assigned to each state of each constituent element, whereby each of them serves as one state confirmation means.

Further, after constructing the simulated system, the verification environment construction unit 110 executes the state confirmation task for all the constituent elements to confirm the current state of the system. The verification environment construction unit 110 sets the aggregation of the states of the constituent elements obtained as a result thereof to be the initial state of the system, generates the initial state information 111 indicating the initial state, and transmits it to the state search unit 120.

FIG. 7 is an explanatory diagram illustrating an example of the initial state information 111. As illustrated in FIG. 7, the initial state information 111 may include, for all the constituent elements, a current state of the constituent elements.

The state search unit 120 extracts all the state transitions of the target system on the basis of the constituent element model information 102, and associates each extracted state transition with the configuration change task. For example, the state search unit 120 extracts all state transitions of the system state represented by a combination of the states of the constituent element models that can transition from the initial state on the basis of the constituent element model information 102, and associates each of them with the state transition task (configuration change task). Further, the state search unit 120 generates, on the basis of the confirmation means information 103, all-state transition information 122 including a method of executing the corresponding configuration change task and a method of confirming the system state after the execution for all the state transitions.

For example, the state search unit 120 may define all combinations of possible states of the constituent element as all states (system states) that the system can enter, and may extract, while assuming each of the system states to be the current state, all system states that can transition from each current state, thereby extracting all state transitions of the system.

Furthermore, the state search unit 120 performs a state search on the basis of the initial state information 111 and the all-state transition information 122. More specifically, the state search unit 120 actually activates all configuration change tasks indicated in the all-state transition information 122 in the verification environment, and determines whether the simulated system make a transition to the target state. The state search unit 120 starts the state search from the system state that is set to be the initial state. The state search is performed for all state transitions that can transition from the initial state. Here, the state transition that can transition includes a case where a transition is made by execution of a plurality of configuration change tasks.

For example, starting from the initial state, the state search unit 120 may sequentially perform, for all the state transitions that can transition, a state change process in which one of the constituent elements included in the current system state is selected, the selected constituent element is caused to transition to another state, and a result thereof is confirmed.

In the present example, the state search unit 120 instructs the state change unit 130 to be described later to perform the state change process. For example, with respect to the target state transition to be confirmed, the state search unit 120 may transmit changing means information 121 including a method of executing the configuration change task and a method of confirming the system state to the state change unit 130. Then, the state search unit 120 receives, from the state change unit 130, the change result 131 indicating success or failure of the configuration change task execution and the confirmed system state as a result of the state change process.

The state search unit 120 may transmit, to the state change unit 130, changing means information 121 including information associated with a plurality of state transitions. In that case, the state change unit 130 may execute a state change task and the state confirmation task as a state change process for each state transition included in the changing means information 121, and may transmit the change result 131 indicating a result thereof.

Upon reception of the change result 131, the state search unit 120 may additionally write the success or failure of the configuration change task execution and the confirmed system state, which are the result of the state change process, in the all-state transition information 122. When all the state transitions included in the all-state transition information 122 have been confirmed, the state search unit 120 notifies the dependence relationship calculation unit 150 accordingly.

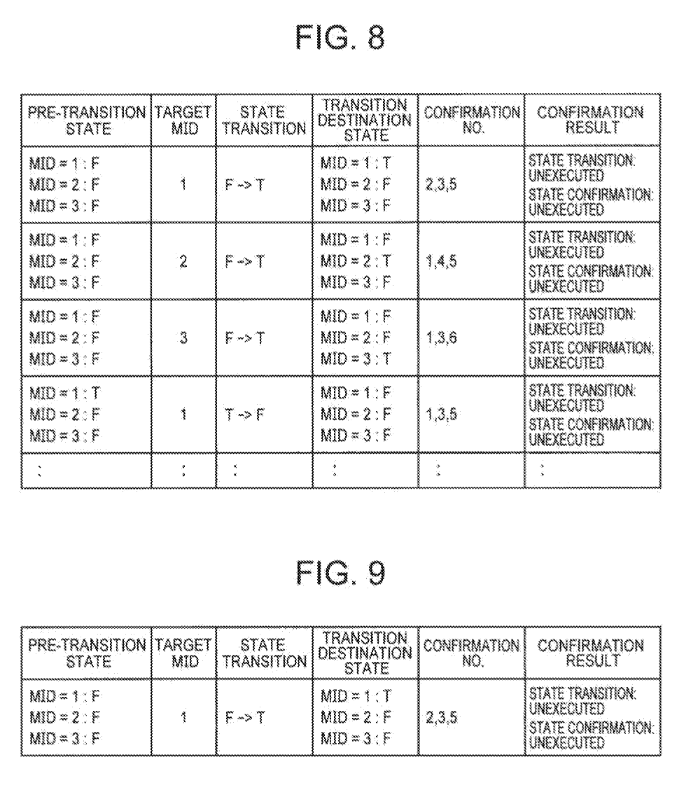

FIG. 8 is an explanatory diagram illustrating an example of the all-state transition information 122. Note that a part of the all-state transition information 122 is illustrated in FIG. 8. Each row of the table illustrated in FIG. 8 corresponds to one state transition. As illustrated in FIG. 8, the all-state transition information 122 may include, for each state transition, a pre-transition state, a target MID, a state transition, a transition destination state, a confirmation number, and a confirmation result.

The pre-transition state is a system state before the state transition. As described above, the system state in the present example is defined by a combination of states of the constituent element to be verified. The target MID is an identifier of the target constituent element whose state is to be changed. The state transition is a state transition for the constituent element indicated by the MID. The transition destination state is a system state after the state transition. The confirmation number is an identifier of the state confirmation means for confirming the system state after the transition. Note that the confirmation result includes success or failure of the state transition and consistency of the system state after the state transition. In the drawing, “state transition: unexecuted” indicates an unexecuted (unsearched) state transition task. Besides, “state confirmation: unexecuted” indicates an unexecuted state confirmation task.

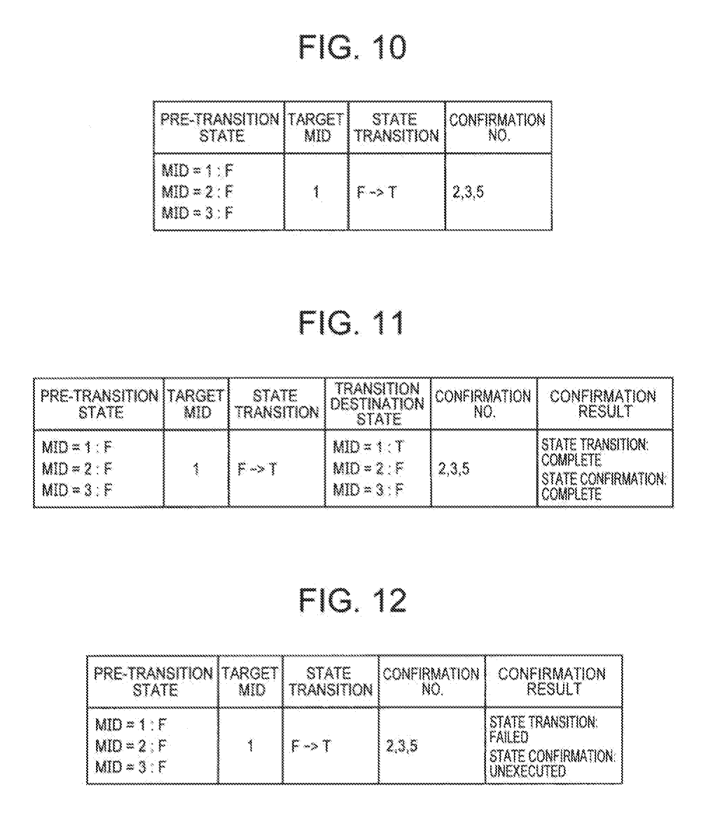

The changing means information 121 may include information required for the state change process. FIGS. 9 and 10 are explanatory diagrams illustrating examples of the changing means information 121. As illustrated in FIG. 9, the changing means information 121 may use information associated with the state transition to be confirmed from the all-state transition information 122 as it is. In addition, as illustrated in FIG. 10, the changing means information 121 may a part of the information associated with the state transition to be confirmed in the all-state transition information 122. Note that the changing means information 121 is not limited thereto, and may further include, for example, information associated with the state change task and information associated with the state confirmation means.

In the example illustrated in FIGS. 9 and 10, when all the states of the constituent element are F as the current state of the system, it is instructed to execute the state transition task for changing the constituent element of MID=1 from the state F to the state T, and to execute respective state confirmation tasks indicated by the confirmation numbers 2, 3, and 5 to confirm the system state. As illustrated in the drawing, the identifier of the state confirmation means may be designated as the information associated with the state confirmation means. At that time, identifiers of a plurality of state confirmation means may be designated. Although the columns of the transition destination state and the confirmation result are provided in advance in the example illustrated in FIG. 9, those columns may be omitted as illustrated in FIG. 10.

The state change unit 130 obtains the changing means information 121, and accesses the verification environment on the basis of the information. Further, the state change unit 130 executes the state confirmation task and the state confirmation task on the basis of the changing means information 121, and stores the change result 131 indicating the result thereof in the change result storage unit 140. At that time, the state change unit 130 may store the change result 131 in the change result storage unit 140, and may transmit it to the state search unit 120.

The change result 131 is information indicating a result of the state change process indicated in the changing means information 121. FIGS. 11 and 12 are explanatory diagrams illustrating examples of the change result 131. As illustrated in the drawing, the change result 131 may be information in which a confirmation result is added to the changing means information 121. Here, the confirmation result may include, for example, an execution result of the state transition task corresponding to the state transition indicated by the changing means information 121, and an execution result of the confirmation means (state confirmation task) corresponding to the confirmation number indicated by the changing means information 121. In the confirmation result in the drawing, “state transition: complete” indicates that all state transition tasks have succeeded. In addition, “state confirmation: complete” indicates that all state confirmation tasks have succeeded. When “failed” is written instead of “complete”, it indicates that the task has failed. For example, “state transition: failed” indicates that the state transition task has failed. Further, for example, “state confirmation: failed” indicates that any state confirmation task has failed. In the example illustrated in FIG. 12, it is unnecessary to confirm the state due to the failure of the state transition task, whereby “unexecuted” representing that the task is unexecuted is written in the result of the state confirmation task.

The state search unit 120 performs a state search while managing the current state of the simulated system on the basis of the confirmation result indicated in the change result 131. For example, when the change result 131 indicating that the state transition task and the state confirmation task has succeeded with respect to the requested changing means information 121 is received, the state search unit 120 may update the current state of the simulated system to the transition destination state indicated by the requested changing means information 121. Further, for example, when the change result 131 indicating that either the state transition task or the state confirmation task has failed with respect to the requested changing means information 121 is received, the state search unit 120 may leave the current state of the simulated system as it is. When the change result 131 indicating that the state transition task or the state confirmation task has failed is received, for example, the state search unit 120 may separately perform processing of confirming the current state of the system on the basis of the confirmation means information 103 to specify the current state of the system.

Furthermore, when the state after the transition can be specified from the success or failure of the state transition task execution, the processing of obtaining the confirmation means information 103 and of confirming the state may be omitted.

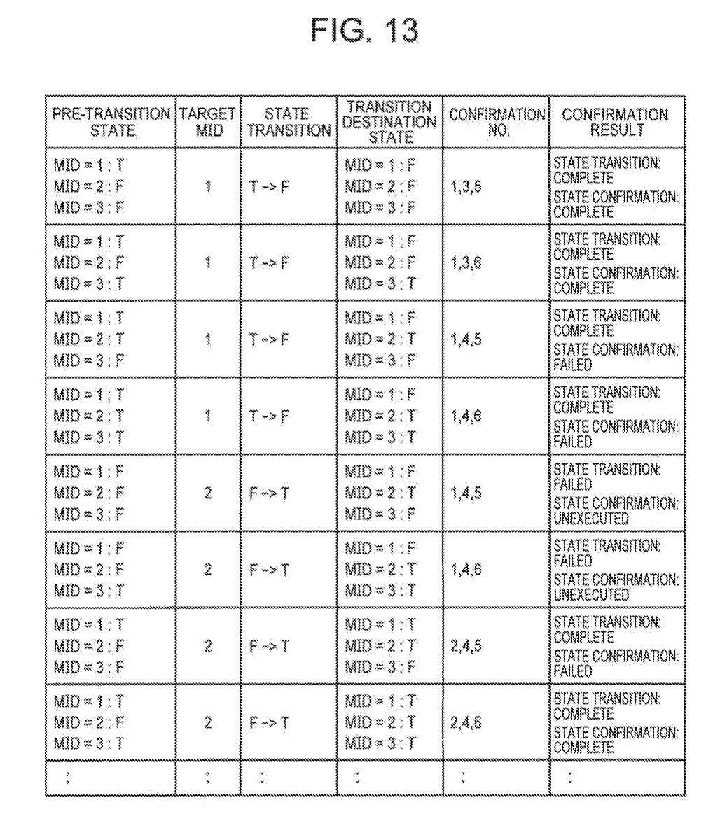

The change result storage unit 140 stores the change result 131 for all the state transitions indicated in the all-state transition information 122. For example, as illustrated in FIG. 13, the change result storage unit 140 may store information in which confirmation results are added to respective rows of the all-state transition information 122. FIG. 13 is an explanatory diagram illustrating an example of information to be stored in the change result storage unit 140.

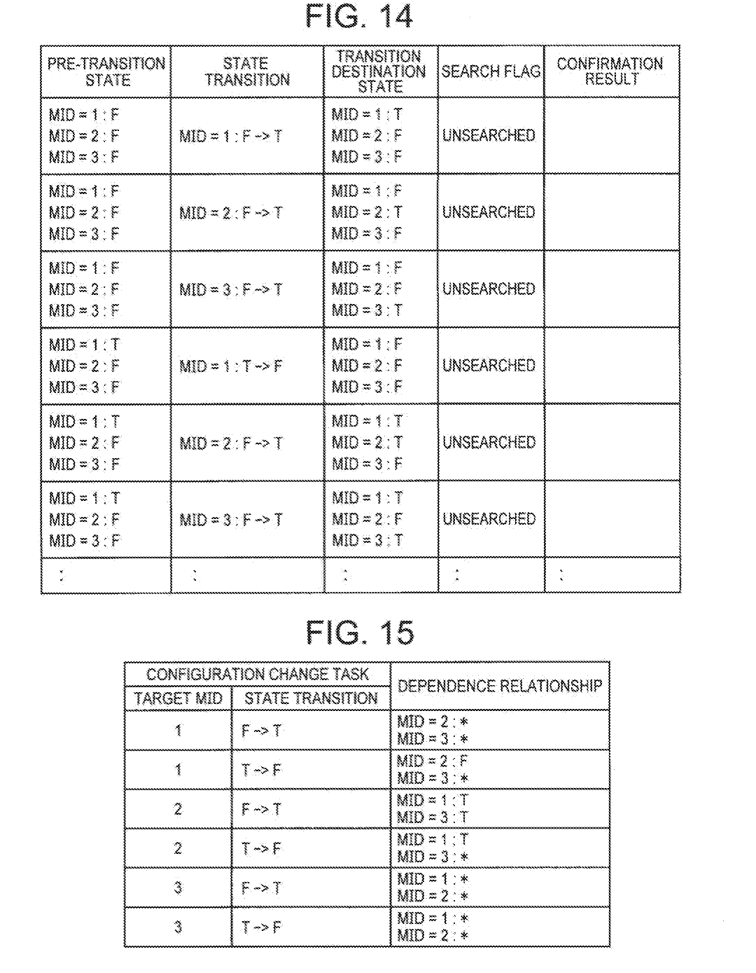

FIG. 14 is an explanatory diagram illustrating another example of the information to be stored in the change result storage unit 140. As illustrated in FIG. 14, the change result storage unit 140 may store the change result 131 for all the state transitions indicated in the all-state transition information 122 in a format different from the all-state transition information 122. In FIG. 14, information including a transition source state, a state transition, a post-transition state, a flag indicating a state of searched or unsearched, and a confirmation result is illustrated. In the present example as well, the contents of the change result 131 are reflected in the column of the confirmation result.

The dependence relationship calculation unit 150 obtains the change result 131 for all the state transitions from the change result storage unit 140, and calculates the dependence relationship between the configuration change task and the state of the constituent element. Further, the dependence relationship calculation unit 150 outputs the dependence relationship information 151 indicating the calculated dependence relationship.

The dependence relationship information 151 is information indicating the dependence relationships with states of other constituent elements with respect to all configuration change tasks to be verified. For example, as illustrated in FIG. 15, the dependence relationship information 151 may include MID of the constituent element to be changed (target constituent element), a state transition of the constituent element indicated by MID, and a dependence relationship of the state transition, that is, a state of other constituent elements required for the state transition. FIG. 15 is an explanatory diagram illustrating an example of the dependence relationship information 151.

For example, the dependence relationship calculation unit 150 may extract, from among state transition patterns of the system state included in the all-state transition information 122, the patterns in which the state transition of the target constituent element is performed, and when the confirmation result of the state transition and the state confirmation is normal in all the extracted patterns, it may be determined that there is no dependence relationship with other configuration change tasks included in the configuration change task that performs the state transition. Meanwhile, in the case where the extracted patters includes a pattern in which the confirmation result of the state confirmation or the state transition is abnormal, and where a pattern in which the state of the transition source of the constituent element other than the target constituent element is different and the confirmation result of the state confirmation and the state transition is normal is included, the dependence relationship calculation unit 150 may compare the transition source states of the normal pattern and the abnormal pattern to calculate the state of other constituent elements that is a necessary condition of the state transition, and it may be set as the dependence relationship.

For example, in FIG. 15, it is illustrated that the state transition for making transition of the constituent element of MID=1 from the state F to the state T is not dependent on the states of the constituent element of MID=2 and the constituent element of MID=3. In other words, it is illustrated that the state transition can be executed regardless of the states of the constituent elements of MID=2 and 3. Note that “*” in the drawing indicates that the transition can be made in an arbitrary state, that is, the transition of the target constituent element can be made in any state.

Further, FIG. 15 illustrates that, although the state transition for making transition of the constituent element of MID=1 from the state T to the state F can be executed regardless of the state of the constituent element of MID=3, it cannot be executed unless the constituent element of MID=2 is in the state F, for example.

In the present exemplary embodiment, the verification environment construction unit 110, the state search unit 120, the state change unit 130, and the dependence relationship calculation unit 150 are implemented by an information processing apparatus such as a CPU that operates according to a program, for example. The change result storage unit 140 is implemented by a storage device.

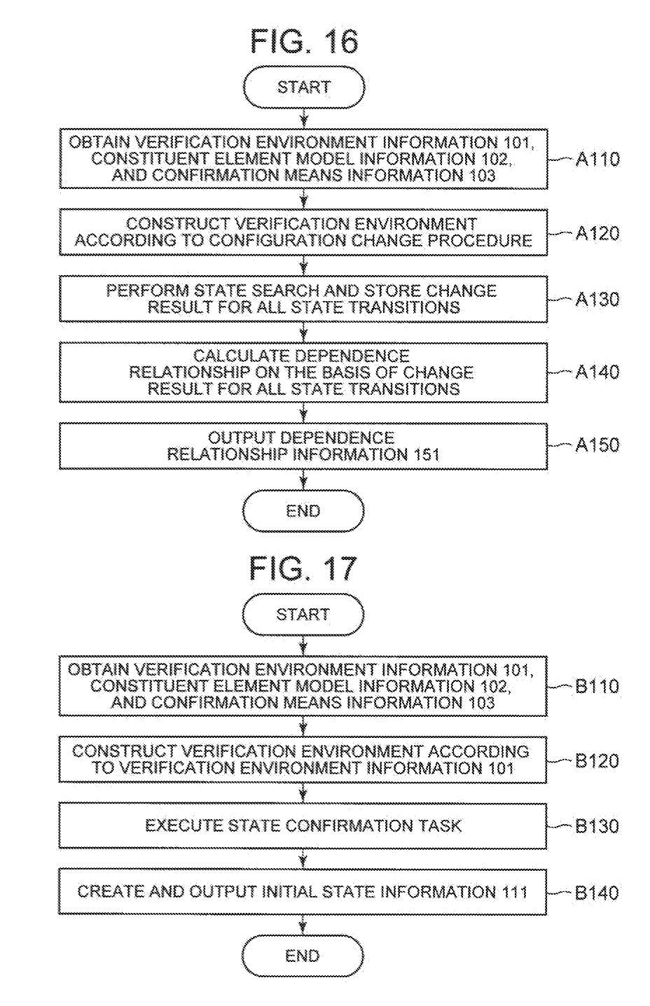

Next, operation of the present exemplary embodiment will be described. FIG. 16 is a flowchart illustrating an outline of the operation of the dependence relationship extracting apparatus 100 according to the present exemplary embodiment. In the example illustrated in FIG. 16, first, the dependence relationship extracting apparatus 100 obtains the verification environment information 101, the constituent element model information 102, and the confirmation means information 103 (step A110).

Next, the dependence relationship extracting apparatus 100 constructs a verification environment using the verification environment construction unit 110 on the basis of the verification environment information 101 (step A120).

Next, the dependence relationship extracting apparatus 100 performs a state search using the state search unit 120 and the state change unit 130, and stores the change result 131 for all state transitions in the change result storage unit 140 (step A130).

Next, the dependence relationship extracting apparatus 100 calculates a dependence relationship between the configuration change task and the state of the constituent element using the dependence relationship calculation unit 150 on the basis of the change result 131 stored in the change result storage unit 140 (step A140). Further, the dependence relationship extracting apparatus 100 outputs the dependence relationship information 151 indicating the calculated dependence relationship (step A150).

FIG. 17 is a flowchart illustrating exemplary operation of the verification environment construction unit 110. In the example illustrated in FIG. 17, first, the verification environment construction unit 110 obtains the verification environment information 101, the constituent element model information 102, and the confirmation means information 103 (step B110).

Next, the verification environment construction unit 110 constructs a simulated system that is a verification environment on the basis of the verification environment information 101, particularly the system construction procedure information (step B120). For example, when the verification environment information 101 illustrated in FIG. 2 is referred to, first, the verification environment construction unit 110 executes the execution contents associated with the procedure number=1. More specifically, the verification environment construction unit 110 accesses the cloud infrastructure that is the basic element of the basic element ID=1, and activates the virtual machine that is the basic element of the basic element ID=2.

Next, the verification environment construction unit 110 executes a state confirmation task to confirm the initial state of the system state (step B130). For example, the verification environment construction unit 110 may execute all state confirmation tasks included in the confirmation means information 103. In the example of the confirmation means information 103 illustrated in FIG. 5, for example, the state confirmation tasks of the confirmation numbers 1, 2, and 3 are executed, whereby the state confirmation of three constituent element models can be performed. Further, in the example of the confirmation means information 103 illustrated in FIG. 6, for example, the state confirmation tasks of the confirmation numbers 1, 2, 3, 4, 5, and 6 are executed, whereby the state confirmation of three constituent element models can be performed. In the example of FIG. 6, when the tests of the confirmation numbers 1, 3, and 5 have succeeded, it is found that all states of the constituent elements of MID=1, 2, and 3 are F according to the determination criterion.

Finally, the verification environment construction unit 110 outputs the initial state information 111 indicating the current state of the system obtained as a result of executing the state confirmation task as an initial state (step B140).

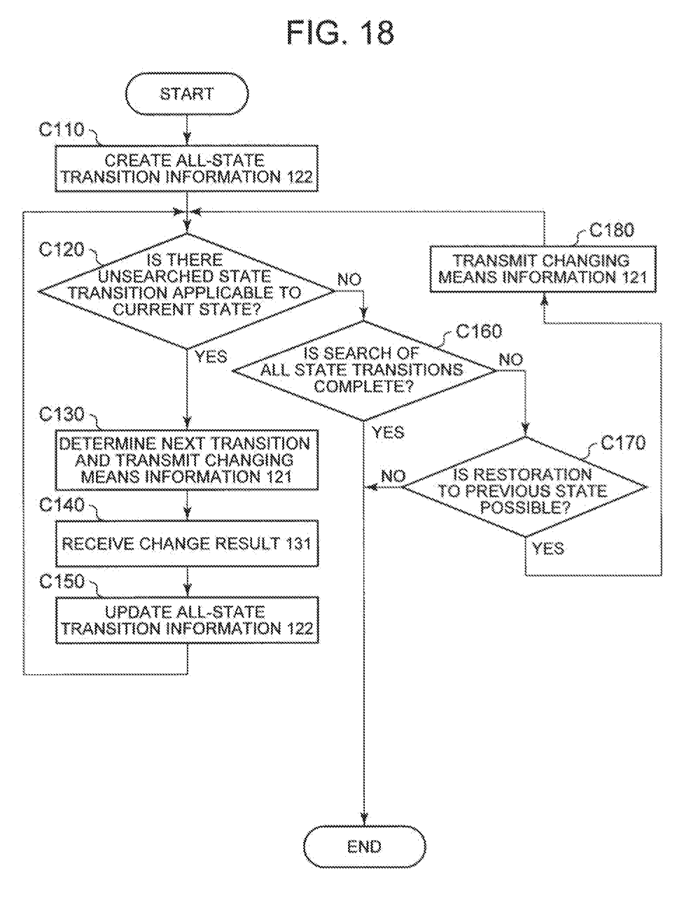

FIG. 18 is a flowchart illustrating exemplary operation of the state search unit 120. In the example illustrated in FIG. 18, first, the state search unit 120 generates the all-state transition information 122, and stores necessary information in the change result storage unit 140 (step C110). At that time, the state search unit 120 may add an identification number to each state transition of the all-state transition information 122, and may store it in the change result storage unit 140.

In the following descriptions, an exemplary case where three constituent elements of MID=1 to 3 are to be verified will be described. FIGS. 8 and 9 mentioned above exemplifies a part of the all-state transition information 122 in the case where three constituent elements are to be verified. Note that, although illustration is omitted, when each constituent element has two states (F and T), there are 8 system states and 24 state transitions of the system in total.

For example, FIG. 9 illustrates, among all state transitions in the case where the constituent elements of MID=1, 2, and 3 are to be verified, the state transition that two pre-transition states ((MID=1, MID=2, MID=3)=(F, F, F), (T, F, F)) can enter. Note that, since there are three transition destination states for one pre-transition state in FIG. 9, information regarding six state transitions are illustrated.

The all-state transition information 122 includes information indicating whether each state transition is unsearched. In the example illustrated in FIG. 8, the confirmation result for the state transition task indicates whether the state transition is unsearched.

Next, the state search unit 120 starts a state search. More specifically, the state search unit 120 determines whether there is an unsearched state transition that is applicable to the current state of the simulated system in the all-state transition information 122 (step C120). For example, when the current state of the simulated system is the initial state illustrated in FIG. 7, that is, (MID=1, MID=2, MID=3)=(F, F, F), unsearched state transitions (state transitions illustrated in one to three rows in the drawing) are extracted from the state transitions in which the pre-transition state conforms to the initial state mentioned above from the all-state transition information 122 illustrated in FIG. 8.

When there are unsearched state transitions that can be applied to the current state of the simulated system (Yes in step C120), the state search unit 120 selects one state transition from among them, and transmits the changing means information 121 corresponding to the selected state transition to the state change unit 130 (step C130).

For example, when the first row of the all-state transition information 122 illustrated in FIG. 8 is selected, the state search unit 120 may transmit the changing means information 121 illustrated in FIGS. 9 and 10 to the state change unit 130. According to the changing means information 121, it is found that, in the current state of the system ((MID=1, MID=2, MID=3)=(F, F, F)), transition of the state of the constituent element of MID=1 from F to T and execution of the state confirmation tasks of confirmation numbers 2, 3, and 5 of the confirmation means information 103 for confirmation of the post-transition state are instructed.

Next, the state search unit 120 receives the change result 131 (step C140). Upon reception of the change result 131, the state search unit 120 reflects the contents of the received change result 131 in the all-state transition information 122 of the change result storage unit 140 (step C150). For example, when the change result 131 illustrated in FIG. 11 is received in step C140, the state search unit 120 may change the search flag in the first row of the information illustrated in FIG. 17 to “searched”, and may add the contents of the change result 131 to the confirmation result.

Further, the state search unit 120 updates the current state of the system in step C150. For example, the change result 131 illustrated in FIG. 11 is received, the state search unit 120 updates the current state to (MID=1, MID=2, MID=3)=(T, F, F).

The state search unit 120 repeats the operations from steps C130 to C150 until there is no unsearched state transition applicable to the current system state.

Meanwhile, when there is no unsearched state transition applicable to the current system state (No in step C120), the state search unit 120 determines whether the search of all state transitions is complete (step C160). When it is determined that all state transitions is complete in step C160 (Yes in step C160), the state search unit 120 terminates the process.

On the other hand, when it is determined that the search of all state transitions is incomplete in step C160 (No in step C160), the state search unit 120 then determines whether the system state can be restored to the previous state (step C170). Here, the previous state may be any state as long as it is the pre-transition state of the unsearched state transition, and includes a state that can transition through several state transitions. For example, the state search unit 120 may determine whether the state can be restored to the previous state depending on whether the previous state exists in the post-transition state of the all-state transition information 122.

When it is determined that the state can be returned to the previous state (Yes in step C170), the state search unit 120 generates the changing means information 121 for restoring the state to the previous state, and transmits it to the state change unit 130 (step C180). On the other hand, when it is determined that the state cannot be restored to the pre-transition state in step C170 (No in step C170), the state search unit 120 terminates the process.

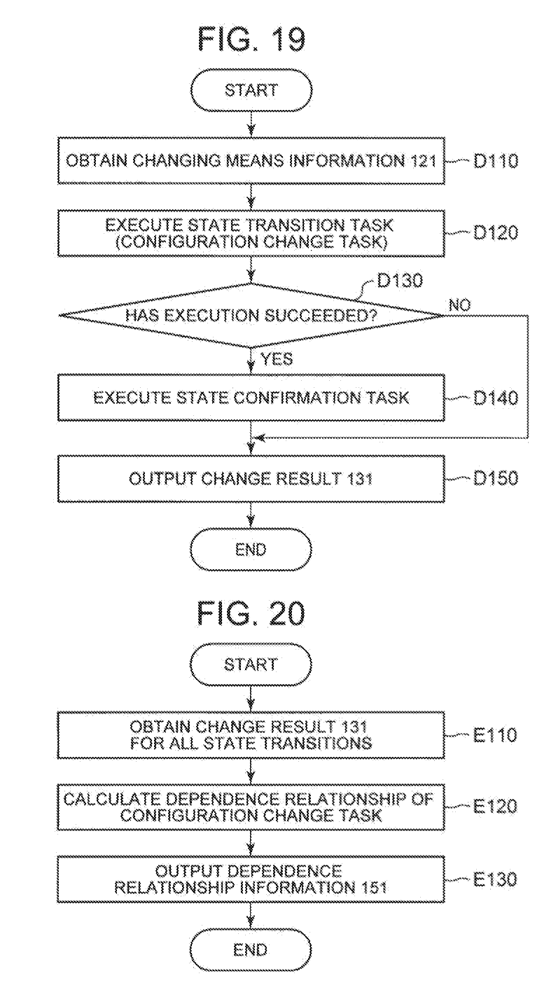

FIG. 19 is a flowchart illustrating exemplary operation of the state change unit 130. In the example illustrated in FIG. 19, first, the state change unit 130 obtains the changing means information 121 (step D110).

Next, the state change unit 130 executes the state transition task (configuration change task) corresponding to the state transition indicated by the obtained changing means information 121 (step D120). In step D120, the state change unit 130 may search and execute the state transition task corresponding to the state transition indicated by the changing means information 121 from the constituent element model information 102. For example, when the changing means information 121 illustrated in FIG. 9 is received, the state change unit 130 searches the constituent element model information 102 for the state transition task for making transition of the state of the constituent element of MID=1 from F to T. Then, the state change unit 130 may execute the obtained state transition task “apt install apache2”.

Next, the state change unit 130 determines whether the state transition task has succeeded (step D130). When the state transition task has succeeded (Yes in step D130), the state change unit 130 then executes the state confirmation task (step D140). For example, the state change unit 130 may search the confirmation means information 103 for the state confirmation task corresponding to the confirmation number indicated by the changing means information 121, and may executed the obtained state confirmation task.

Finally, the state change unit 130 transmits the change result 131 indicating the execution result of the state transition task and the state confirmation task to the state search unit 120, and the process is terminated (step D150).

On the other hand, when the state transition task has failed (No in step D130), the state change unit 130 transmits the change result 131 indicating that status to the state search unit 120, and the process is terminated (step D150).

FIG. 20 is a flowchart illustrating exemplary operation of the dependence relationship calculation unit 150. In the example illustrated in FIG. 20, first, the dependence relationship calculation unit 150 obtains the change result 131 for all state transitions from the change result storage unit 140 (step E110).

Next, the dependence relationship calculation unit 150 refers to the obtained change result 131, and calculates the dependence relationship of the configuration change task corresponding to each state transition (step E120).

For example, when the change result storage unit 140 stores information illustrated in FIG. 13, the dependence relationship calculation unit 150 can calculate the precondition that the state transition for making transition of the state of the constituent element of MID=1 from the state T to F cannot be correctly performed unless the state of the constituent element of MID=2 is F. Therefore, the dependence relationship calculation unit 150 generates the dependence relationship information 151 indicating MID=2: T as the dependence relationship of the configuration change task corresponding to the state transition. In that case, the constituent element of MID=3 may be in any state.

Further, for example, when the change result storage unit 140 stores information illustrated in FIG. 13, the dependence relationship calculation unit 150 can calculate the precondition that the state transition for making transition of the state of the constituent element of MID=2 from the state F to T cannot be correctly performed unless the states of the constituent elements of MID=1 and 3 are T. Therefore, the dependence relationship calculation unit 150 generates the dependence relationship information 151 indicating MID=1: T and MID=3: T as the dependence relationship of the configuration change task corresponding to the state transition.

As described above, according to the present exemplary embodiment, the dependence relationship between the configuration change task and the state of the constituent element to be used at the time of generating the system construction procedure can be extracted without causing an error in the real environment.

That is, the dependence relationship extracting apparatus 100 according to the present exemplary embodiment can provide, for all configuration change tasks to be verified, the dependence relationship information 151 indicating the state of the constituent element capable of executing the task on the basis of the verification environment information 101, the constituent element model information 102, and the confirmation means information 103 without manual operation.

More specifically, in the dependence relationship extracting apparatus 100 according to the present exemplary embodiment, the verification environment construction unit 110 constructs the verification environment on the basis of the verification environment information 101. Then, on the basis of the constituent element model information 102 and the confirmation means information 103, the state search unit 120 cooperates with the state change unit 130 to verify whether the target system configuration change task in the dependence relationship extracting apparatus 100 operates in such a manner that can be executed in all possible situations and as expected, and stores the verification result in a database (change result storage unit 140). Then, the dependence relationship calculation unit 150 refers to this database, and generates and outputs the dependence relationship information 151.

In this manner, the dependence relationship extracting apparatus 100 confirms the operation in all the situations that can be taken by the target configuration change task using the verification environment, and calculates, on the basis of the result thereof, the dependence relationship related to the state of the constituent element included in each configuration change task. Therefore, the dependence relationship extracting apparatus 100 can correctly and easily extract the dependence relationship between the configuration change tasks or between the configuration change task and the state of the constituent element.

If the dependence relationship between the configuration change task and the state of the constituent element is extracted, on the basis of the extracted dependence relationship, the dependence relationship between the target configuration change tasks can be extracted. For example, when the dependence relationship in which a certain constituent element needs to be in the F state as a precondition is extracted for a first configuration change task, the dependence relationship in which the first configuration change task is executed after a second configuration change task for making transition of the constituent element from another state to the state F can be extracted.

Further, for example, when the system construction procedure is given first, the dependence relationship extracting apparatus 100 according to the present exemplary embodiment may determine whether the precondition is satisfied in the order relationship of the configuration change task included in the procedure on the basis of the extracted dependence relationship. Then, when there is a configuration change task in which the precondition is unsatisfied, it is also possible to change the order, to add a new configuration change task, and the like.

Although the configuration change task to be verified is limited to the state transition task on the premise that the state and the state transition of the constituent element corresponding to the configuration change to be verified are determined in advance in the example described above, the task to be verified is not limited to the state transition task. For example, a configuration change task without a state transition may be included in the verification target. In that case, the state search unit 120 may execute all the configuration change tasks to be verified in all patterns that can be taken by the system state defined by the combination of the states of the constituent element, and may obtain the result thereof. In that case, the state search unit 120 may generate, instead of the all-state transition information 122, information in which respective patterns that can be taken by the system state are associated with respective configuration change tasks to be verified. Further, the change result storage unit 140 may store the execution result of each configuration change task in each of all the patterns that can be taken by the system state, such as adding the confirmation result to the information. Note that the dependence relationship extracting apparatus 100 may obtain the information associated with the configuration change task to be verified separately from the constituent element model information 102.

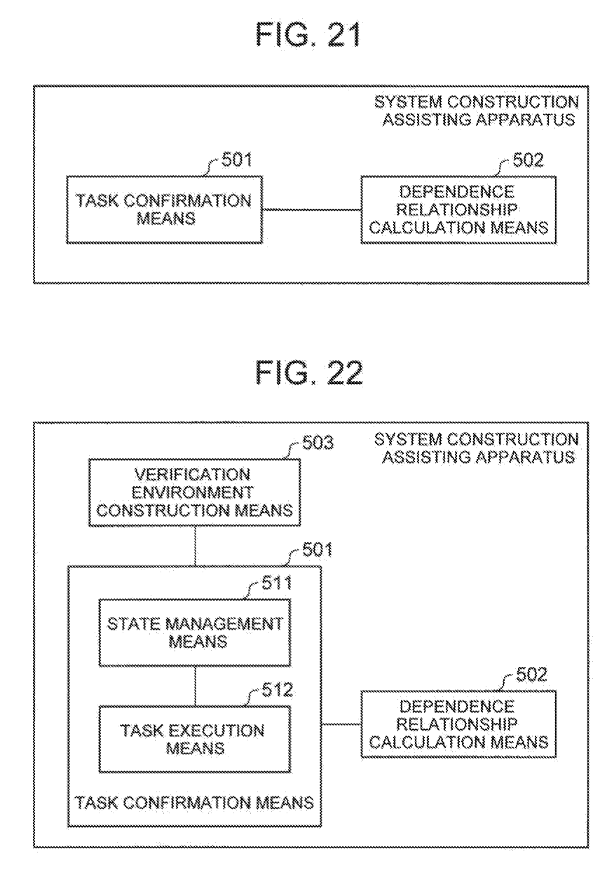

Next, an outline of the present invention will be described. FIG. 21 is a block diagram illustrating the outline of the present invention. As illustrated in FIG. 21, the system construction assisting system according to the present invention includes a task confirmation means 501, and a dependence relationship calculation means 502.

The task confirmation means 501 (e.g., state search unit 120 and state change unit 130) inputs information indicating the configuration change task to be verified, information indicating the state that can be taken by each constituent element of the target system, and information indicating the state transition task for making transition of each constituent element between states, and changes the state of the simulated system that operates in the manner same as the target system to execute the configuration change task, thereby obtaining the execution result of the configuration change task in all system states that can be taken by the target system.

Further, the dependence relationship calculation means 502 (e.g., dependence relationship calculation unit 150) calculates the dependence relationship of each of the configuration change tasks on the basis of the execution result of the task confirmation means 501, and outputs information indicating the calculated dependence relationship.

With such a configuration, the execution result of the configuration change task can be exhaustively obtained by the operation verification performed by the simulated system, whereby the dependence relationship between the configuration change tasks or between the configuration change task and the state of the constituent element can be correctly extracted.

FIG. 22 is a block diagram illustrating another exemplary configuration of the system construction assisting apparatus according to the present invention. As illustrated in FIG. 22, the system construction assisting apparatus according to the present invention may further include a verification environment construction means 503.

The verification environment construction means 503 (e.g., verification environment construction unit 110) inputs the verification environment information indicating the procedure of constructing the simulated system in a predetermined environment, and constructs the simulated system in the predetermined environment. In such a case, the task confirmation means 501 may access the simulated system constructed by the verification environment construction means 503 to execute the configuration change task.

Further, the task confirmation means 501 may define the system state of the target system on the basis of the information indicating the states that can be taken by each constituent element of the target system, make a transition of the state of the simulated system to follow the system state of the target system using the state transition task, and execute the applicable configuration change task in each transition destination, thereby obtaining the execution result of the configuration change task in all the system states that can be taken by the target system.

When all of the configuration change tasks to be verified are state transition tasks, the task confirmation means 501 may execute the state transition task at the time of making transition of the state of the simulated system as a configuration change task.

Moreover, the task confirmation means 501 may further input information indicating the determination criterion of the state of the constituent element using the state confirmation task for confirming the state of the constituent element and the execution result of the state confirmation task to execute the state confirmation task after the execution of the configuration change task, and may obtain the result thereof. In such a case, the dependence relationship calculation means 502 may calculate the dependence relationship of each configuration change task on the basis of the execution results of the configuration change task and the state confirmation task.

As illustrated in FIG. 22, the task confirmation means 501 may include a state management means 511 (e.g., state search unit 120) that defines the system state of the target system on the basis of the information indicating the state that can be taken by each constituent element of the target system and manages the state of the simulated system to follow the system state of the target system, and a task execution means 512 (e.g., state change unit 130) that executes the state transition task and/or the configuration change task in the simulated system in accordance with an instruction from the state management means 511 and obtains the result thereof.

Although the present invention has been described with reference to the present exemplary embodiment and examples, the present invention is not limited to the exemplary embodiment and the examples described above. Various modifications that can be understood by those skilled in the art can be made to the configuration and details of the present invention within the scope of the present invention.

The present application claims priority based on Japanese Patent Application No. 2016-214403 filed on Nov. 1, 2016, the disclosure of which is incorporated herein in its entirety.

### INDUSTRIAL APPLICABILITY

The present invention can be suitably used not only when a system construction procedure is generated but also for all usages that uses a configuration change task accompanying a state transition of a constituent element.

### REFERENCE SIGNS LIST

100 Dependence relationship extracting apparatus
101 Verification environment information
102 Constituent element model information
103 Confirmation means information
110 Verification environment construction unit
111 Initial state information
120 State search unit
121 Changing means information
122 All-state transition information
130 State change unit
131 Change result
140 Change result storage unit
150 Dependence relationship calculation unit
151 Dependence relationship information
501 Task confirmation means
502 Dependence relationship calculation means
503 Verification environment construction means
511 State management means
512 Task execution means

What is claimed is:

1. A system construction assisting apparatus, comprising:
a task confirmation unit that changes, with information indicating a configuration change task to be verified, information indicating a state that each constituent element of a target system can enter, and information indicating a state transition task for making transition of each constituent element between the states serving as input, a state of a simulated system that performs operation same as operation of the target system and executes the configuration change task to obtain an execution result of the configuration change task in all system states that the target system can enter; and
a dependence relationship calculation unit that calculates a dependence relationship of each of the configuration change task on the basis of the execution result and outputs information indicating a calculated dependence relationship.

2. The system construction assisting apparatus according to claim 1, further comprising:
a verification environment construction unit that constructs, with verification environment information indicating a procedure of constructing the simulated system in a predetermined environment serving as input, the simulated system in the predetermined environment.

3. The system construction assisting apparatus according to claim 1, wherein
the task confirmation unit defines a system state of the target system on the basis of the information indicating a state that each constituent element of the target system can enter, makes a transition of a state of the simulated system to follow the system state of the target system using the state transition task, and executes an applicable configuration change task in each of transition destinations to obtain the execution result of the configuration change task in all the system states that the target system can enter.

4. The system construction assisting apparatus according to claim 3, wherein
all of the configuration change tasks to be verified are state transition tasks, and
the task confirmation unit executes the state transition task at a time of making transition of the state of the simulated system as the configuration change task.

5. The system construction assisting apparatus according to claim 1, wherein
the task confirmation unit executes, with information indicating a state confirmation task for confirming a state of a constituent element and a determination criterion of the state of the constituent element using an execution result of the state confirmation task further serving as input, the state confirmation task after execution of the configuration change task to obtain a result of the task, and
the dependence relationship calculation unit calculates the dependence relationship of each of the configuration change task on the basis of the execution results of the configuration change task and the state confirmation task.

6. The system construction assisting apparatus according to claim 1, wherein
the task confirmation unit includes:
a state management unit that defines the system state of the target system on the basis of the information indicating a state that each constituent element of the target system can enter and manages the state of the simulated system to follow the system state of the target system; and
a task execution unit that executes the state transition task and/or the configuration change task in the simulated system in accordance with an instruction from the state management unit to obtain a result of the execution.

7. A method of assisting system construction, comprising:
changing, when information indicating a configuration change task to be verified, information indicating a state that each constituent element of a target system can enter, and information indicating a state transition task for making transition of each constituent element between the states are input, a state of a simulated system that performs operation same as operation of the target system, and executing the configuration change task to obtain an execution result of the configuration change task in all system states that the target system can enter; and
calculating a dependence relationship of each of the configuration change task on the basis of the execution result, and outputting information indicating a calculated dependence relationship.

8. The method of assisting system construction according to claim 7, further comprising:
constructing, when verification environment information indicating a procedure of constructing the simulated system in a predetermined environment is input, the simulated system in the predetermined environment on the basis of the verification environment information; and
accessing the simulated system and executing the configuration change task.

9. A non-transitory computer readable recording medium in which a system construction assisting program is recorded, the system construction assisting program causing a computer to perform:
processing of changing, with information indicating a configuration change task to be verified, information indicating a state that each constituent element of a target system can enter, and information indicating a state transition task for making transition of each constituent element between the states serving as input, a state of a simulated system that performs operation same as operation of the target system and executing the configuration change task to obtain an execution result of the configuration change task in all system states that the target system can enter; and
processing of calculating a dependence relationship of each of the configuration change task on the basis of the execution result and outputting information indicating a calculated dependence relationship.

10. The non-transitory computer readable recording medium according to claim 9, the system construction assisting program causing the computer to perform:
processing of constructing, with verification environment information indicating a procedure of constructing the simulated system in a predetermined environment serving as input, the simulated system in the predetermined environment; and
processing of accessing the simulated system and executing the configuration change task in the processing of obtaining the execution result of the configuration change task.
